(19) United States
(12) Patent Application Publication
(10) Pub. No.: US 2013/0066744 A1
(43) Pub. Date: Mar. 14, 2013

(54) FLEXIBLE SHIPPING DELIVERY

(71) Applicants: Krystal Rose Higgins, Sunnyvale, CA (US); Margaret Szeto, Santa Clara, CA (US); Caroline Juliet Fernandes, San Jose, CA (US); Joel Robert Edelman, San Jose, CA (US); Roel Ramirez, Hayward, CA (US); Stephen Tse, Daly City, CA (US); Amol Vilas Sane, San Jose, CA (US)

(72) Inventors: Krystal Rose Higgins, Sunnyvale, CA (US); Margaret Szeto, Santa Clara, CA (US); Caroline Juliet Fernandes, San Jose, CA (US); Joel Robert Edelman, San Jose, CA (US); Roel Ramirez, Hayward, CA (US); Stephen Tse, Daly City, CA (US); Amol Vilas Sane, San Jose, CA (US)

(73) Assignee: eBay Inc., San Jose, CA (US)

(21) Appl. No.: 13/232,752

(22) Filed: Sep. 14, 2011

(51) Int. Cl. G06Q 30/00

(52) U.S. Cl. 705/26.41

(57) ABSTRACT

A flexible shipping delivery system has an online marketplace interface, a client interface, a shipping carrier interface, and a flexible shipping delivery engine. The online marketplace interface communicates with an online marketplace application. The client interface communicates with a client that places an order for an item on the online marketplace application. The client interface receives a shipping delivery preference of a user of the client. The shipping carrier interface communicates with a shipping carrier server. The shipping carrier server provides a tracking shipping status of the item. The flexible shipping delivery engine adjusts a delivery option of the item based on the tracking shipping status of the item and the shipping delivery preference.

### TECHNICAL FIELD

This application relates generally to the field of computer technology, and in a specific example embodiment, to a system and method for providing flexible shipping delivery of an item.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

The user will typically have to specify the destination address where the user would like the item to be shipped. The destination address may be, for example, a residence address or a business address of the user. However, the user may be required to be physically present at the destination address for items requiring a signature confirmation. When the user misses the delivery, the user typically would have to pick up the item at a predetermined location causing much frustration and wasted time.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of a flexible shipping delivery application;

FIG. 3 is a block diagram illustrating an example embodiment of a user delivery instructions module;

FIG. 4 is a block diagram illustrating an example embodiment of a remote presence module;

FIG. 5 is a flow chart of one embodiment of a method for providing a flexible shipping delivery;

FIG. 6 is a flow chart of another embodiment of a method for providing a flexible shipping delivery;

FIG. 7 is a flow chart of one embodiment of a method for providing an electronic signature for a flexible shipping delivery;

FIG. 8 is a flow chart of one embodiment illustrating a flexible shipping delivery system that notifies and communicates shipping status information, user preferences, and user receipt confirmation between shipping carriers and customers; and

FIG. 9 shows a diagrammatic representation of machine in the example form of a computer system within which a set of instructions may be executed to cause the machine to perform any one or more of the methodologies discussed herein.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, a system and method for a flexible shipping delivery is described. A shipping delivery application can help shipping carriers interface with numerous online customers and their shipments by sending notifications of shipment statuses and opportunities to adjust delivery options to a customer. The shipping delivery application can store the user's preset delivery preferences and electronic signatures (or any other types of encrypted identity/confirmation mechanisms, such as fingerprints, Personal Identification Number (PIN) codes, etc.) to transmit to the shipping carriers when needed.

For example, when the shipping carrier is at the customer's door and no one is there to receive the package, the user's electronic signature can be sent to shipping carrier to literally sign for the package, so as to save another trip for the carrier or the customer. In addition to storing the users preset delivery preferences and the electronic signatures, the flexible shipping delivery application can facilitate in real-time the statuses of the shipment to the user and the communication of the user's preferences to the shipping carrier. These notifications can be sent to and from various platforms, such as mobile devices.

In one embodiment, the flexible shipping delivery system has an online marketplace interface, a client interface, a shipping carrier interface, and a flexible shipping delivery engine. The online marketplace interface communicates with an online marketplace application. The client interface communicates with a client that places an order for an item on the online marketplace application. The client interface receives a shipping delivery preference of a user of the client. The shipping carrier interface communicates with a shipping carrier server. The shipping carrier server provides a tracking shipping status of the item. The flexible shipping delivery engine adjusts a delivery option of the item based on the tracking shipping status of the item and the shipping delivery preference.

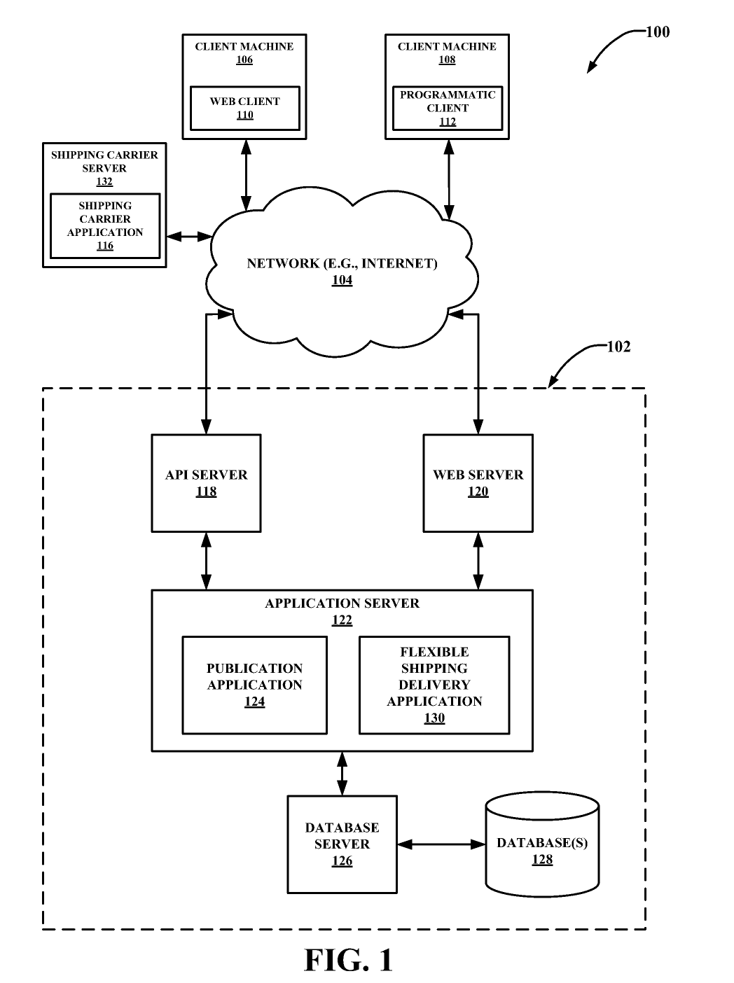

FIG. 1 is a network diagram depicting a network system 100, according to one embodiment, having a client-server architecture configured for exchanging data over a network. For example, the network system 100 may be a network-based publisher 102, where clients may communicate and exchange data within the network system 100. The data may pertain to various functions (e.g., online item purchases) and aspects (e.g., managing order information) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet), to one or more clients. The one or more clients may include users that utilize the network system 100 and, more specifically, the publication/publisher system 102, to exchange data over the network 104. These transactions may include transmitting, receiving (communicating) and processing data to, from, and regarding content and users of the network system 100. The data may include, but are not limited to, content and user data such as order tracking information; alternative fulfillment data; feedback data; user reputation values; user profiles; user attributes; product and service reviews and information (such as pricing and descriptive information); product, service, manufacturer, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client (e.g., web browser) 110. The web client 110 may be in communication with the network-based publisher 102 via a web server 120. The UIs may also be associated with a client machine 108 using a programmatic client 112, such as a client application. It can be appreciated that in various embodiments, the client machines 106 and 108 may be associated with a buyer, a seller, a third party electronic commerce platform, and/or a payment service provider. The buyers and sellers may be any one of individuals, merchants, or service providers, among other things.

Furthermore, a shipping carrier server 132 of a shipping service provider may be in communication with the network-based publisher 102 and optionally with client machines 106 and 108. The shipping carrier server 132 includes a shipping carrier application 116 to provide a shipping tracking mechanism to the client machines 106 and 108 and the application server 122. The shipping tracking mechanism allows the client machines 106 and 108 and the application server 122 to determine the status of a shipment for an item associated with an order placed by a buyer.

Turning specifically to the network-based publisher 102, an application program interface (API) server 118 and a web server 120 are coupled to, and provide programmatic and web interfaces respectively to, one or more application servers 122. The application servers 122 host a publication application 124 and a flexible shipping delivery application 130. The application servers 122 are, in turn, shown to be coupled to one or more database server(s) 126 that facilitate access to one or more database(s) 128.

In one embodiment, the web server 120 and the API server 118 communicate about and receive data pertaining to listings, transactions, order tracking information, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., web client 110 or shipping carrier application 116) running on another client machine (e.g., shipping carrier server 132).

The publication application 124 may provide a number of publisher functions and services (e.g., listing, payment, etc.) to users that access the network-based publisher 102. For example, the publication application 124 may provide a number of services and functions to users for listing goods and/or services for sale, facilitating transactions, and reviewing and providing feedback about transactions and associated users. The publication application 124 may further provide a shipment status related to a transaction. In one embodiment, the publication application 124 includes an online marketplace.

The flexible shipping delivery application 130 provides flexibility in the shipping delivery of an item ordered on the online marketplace. In one embodiment, the flexible shipping delivery application 130 includes a flexible shipping delivery engine that adjusts a delivery option of the item based on the tracking shipping status of the item and the shipping delivery preference of the customer/user. Embodiments of the flexible shipping delivery application 130 are further described below.

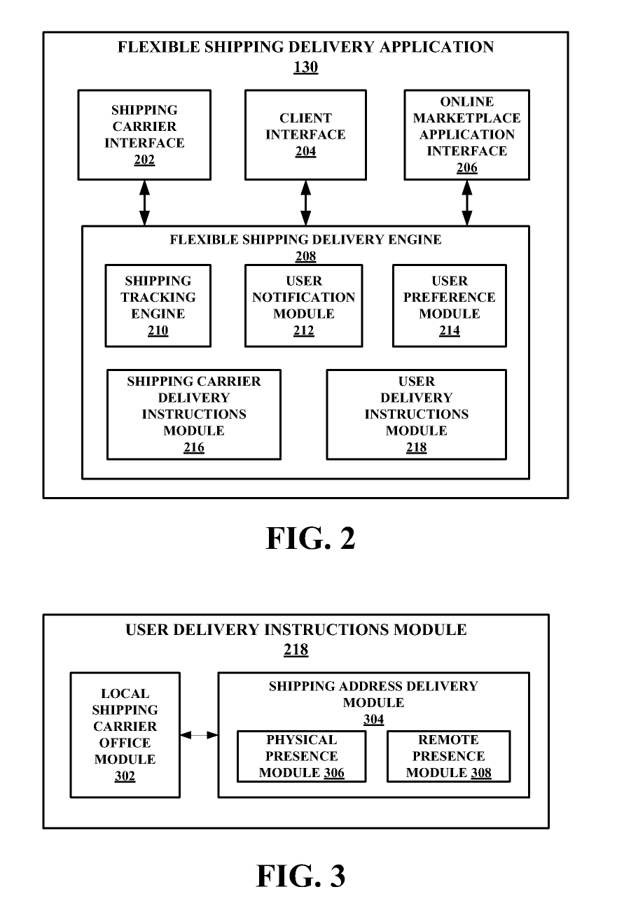

FIG. 2 is a block diagram illustrating an example embodiment of the flexible shipping delivery application 130. The flexible shipping delivery application 130 includes, for example, a shipping carrier interface 202, a client interface 204, an online marketplace application interface 206, and a flexible shipping delivery engine 208.

The online marketplace application interface 206 communicates with an online marketplace application, such as the publication application 124 of FIG. 1. For example, the online marketplace application interface 206 may receive data concerning a transaction between a buyer and a seller from the online marketplace application. The buyer may have placed an order for an item from the seller. The seller is to fulfill the order by shipping the item with a shipping carrier associated with the shipping carrier server 132. In one embodiment, the data may include, for example, the buyer's contact information, the seller's contact information, the shipping carrier's contact information, an identification of the item, and the transaction amount between the buyer and the seller for the item.

In one embodiment, the online marketplace application interface 206 may communicate a shipping status of the item to the online marketplace application. The online marketplace application may use the shipping status of the item to settle all accounts related to the transaction. For example, once the online marketplace application determines that the item has been successfully received by the buyer, the online marketplace application may instruct a payment gateway server to transfer a portion of an amount received from the buyer to the seller.

The client interface 204 communicates with a client of the user or customer. For example, a customer interacts with the web client 110 of the client machine 106 to place an order for an item on the online marketplace application. The user or customer logs in with his account to publication application 124. In one embodiment, the client interface 204 receives a shipping delivery preference of the user at the client machine 106. The shipping delivery preference may include the user's preset preference for the delivery method. For example, the user may prefer to pick up any item ordered through the online marketplace application at a local shipping carrier office. The local shipping carrier office may include the shipping carrier office local to an address of the user. In another example, the user may prefer to have the item delivered at a predetermined address (e.g., residence, business, and so forth). Furthermore, the user may prefer to allow the flexible shipping delivery application 130 to electronically sign for the item (or the shipping package that includes the item) by authorizing a delivery of an electronic signature of the user to the shipping carrier for the delivery of the item at the predetermine address.

The shipping carrier interface 202 communicates with a shipping carrier server, such as the shipping carrier server 132 of FIG. 1. The shipping carrier interface 202 receives a tracking shipping status of the item from the shipping carrier server. In one embodiment, the shipping carrier interface 202 may also be configured to send delivery instructions to the shipping carrier server 132. The delivery instructions may be based on the user's shipping delivery preference and the tracking shipping status of the item.

The flexible shipping delivery engine 208 adjusts a delivery option of the item based on the tracking shipping status of the item and the shipping delivery preference. The delivery option may include delivering the item at a local shipping carrier office for the user to pick up, or delivering the item at a physical address specified by the user. The delivery option may further include remotely providing an electronic signature for a receipt of the item at the physical address.

In one embodiment, the flexible shipping delivery engine 208 includes, for example, a shipping tracking engine 210, a user notification module 212, a user preference module 214, a shipping carrier delivery instructions module 216, and a user delivery instructions module 218.

The shipping tracking engine 210 updates a shipping status of the item based on the tracking shipping status of the item from the shipping carrier server 132 of FIG. 1. For example, the shipping status of the item may include a location of the item at a specified time. The shipping status of the item may inform the flexible shipping delivery engine 208 that the item has arrived at a local shipping carrier office.

The user notification module 212 contacts the user based on the updated shipping status of the item. For example, the user notification module 212 may notify and/or remind the user of the arrival of the package/item at the local shipping carrier office along with pickup details. The pickup details may include instructions on how, when, where, and what to bring to pick up the package/item. In another example, the user notification module 212 notifies the user of the delivery time at the local shipping carrier office. In another example, the user notification module 212 notifies a user of a successful delivery at a physical address specified by the user.

The user preference module 214 determines the shipping delivery preference of the user. As previously described, the shipping delivery preference may include the user's preset preference for the delivery method of the package shipped with a shipping carrier associated with the shipping carrier server 132. For example, the user may prefer to pick up any item ordered through the online marketplace application at a local shipping carrier office. The local shipping carrier office may include the shipping carrier office local to an address of the user. In another example, the user may prefer to have the item delivered at a predetermined address (e.g., residence, business, and so forth). Furthermore, the user may prefer to allow the flexible shipping delivery application to electronically sign for the item (or the shipping package that includes the item) by authorizing a delivery of the user's electronic signature to the shipping carrier for the delivery of the item at the predetermined address. The user preference module 214 may store the user's delivery preference as part of the flexible shipping delivery application 130, or in an external storage device.

The user delivery instructions module 218 determines delivery instructions from the user. For example, the user delivery instructions module 218 first determines whether there are any preset user delivery preferences. If no preset user delivery preferences are found, the user delivery instructions module 218 communicates with the user to obtain updated delivery preferences for the item being currently shipped. One embodiment of the user delivery instructions module 218 is further described below with respect to FIG. 3.

The shipping carrier delivery instructions module 216 provides the delivery instructions of the item as determined from the user delivery instructions module 218 to the shipping carrier server 132 of FIG. 1.

FIG. 3 is a block diagram illustrating an example embodiment of the user delivery instructions module 218. The user delivery instructions module 218 includes, for example, a local shipping carrier office delivery module 302 and a shipping address delivery module 304. The local shipping carrier office delivery module 302 receives instructions from the user for the shipping carrier associated with the shipping carrier server 132 to deliver the item at a local office of the shipping carrier. The shipping address delivery module 304 receives instructions from the user for the shipping carrier to deliver the item at a physical address specified by the user. For example, the physical address may include a business or a residence address of the user or another user.

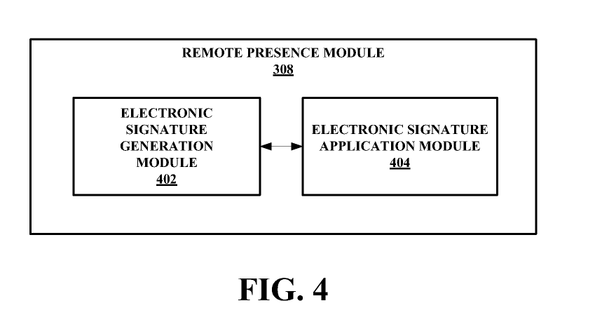

In one embodiment, the shipping address delivery module 304 includes a physical presence module 306 and a remote presence module 308. The physical presence module 306 determines that the user is to be physically present at the physical address at a time of delivery of the item. The remote presence module 308 determines that the user is to remotely sign for the delivery of the item at the physical address using an electronic signature as further described with respect to FIG. 4 below.

FIG. 4 is a block diagram illustrating an example embodiment of the remote presence module 308. The remote presence module 308 includes, for example, an electronic signature generation module 402 and an electronic signature application module 404.

The electronic signature generation module 402 generates an electronic signature of the user based on authenticated information from the user. In one embodiment, the user may be able to create an electronic signature on his or her mobile device. The user would provide his or her signature along with additional information to authenticate the user. The electronic signature generation module 402 communicates the information provided by the user to the publication application 124 of FIG. 4 for authentication. Once the publication application 124 has authenticated the user based on the provided information, the publication application 124 notifies the electronic signature generation module 402 of the authenticity of the information. The electronic signature generation module 402 then stores the user's electronic signature for use by the electronic signature application module 404.

The electronic signature application module 404 submits the electronic signature of the user to the shipping carrier server for the delivery of the item at the physical address. For example, the shipping carrier server 132 may notify the flexible shipping delivery application 130 that the item has been delivered at the physical address specified by the user and that the delivery requires a signature. In turn, the shipping address delivery module 304 may request for a receipt acknowledgement with the user's signature. Once the remote presence module 308 determines that the electronic signature of the user already exists on file with the flexible shipping delivery application 130, the electronic signature application module 404 may transfer the user's electronic signature to the shipping carrier server 132.

In another embodiment, the electronic signature application module 404 further receives a confirmation of a receipt of the electronic signature of the user from the shipping carrier server 132 of FIG. 1.

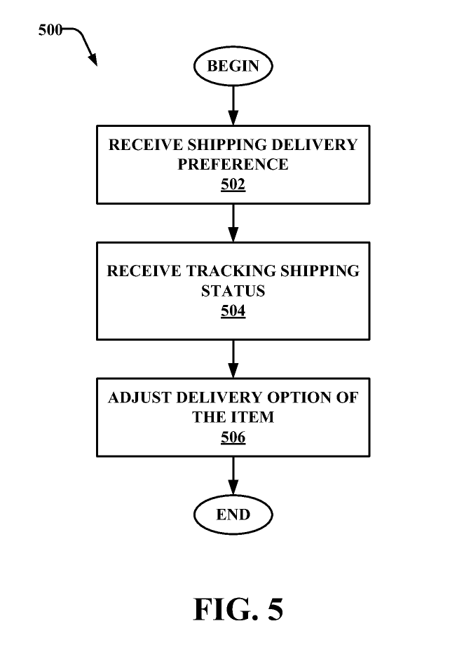

FIG. 5 is a flow chart of one embodiment of a method for providing a flexible shipping delivery. The client places an order for an item on an online marketplace application. At 502, a shipping delivery preference of a user of a client is received. At 504, a tracking shipping status of the item provided by a shipping carrier server is received. At 506, a delivery option of the item is adjusted based on the tracking shipping status of the item and the shipping delivery preference. The delivery option comprises, for example, delivering the item at a local shipping carrier office for the user to pick up, or delivering the item at a physical address specified by the user.

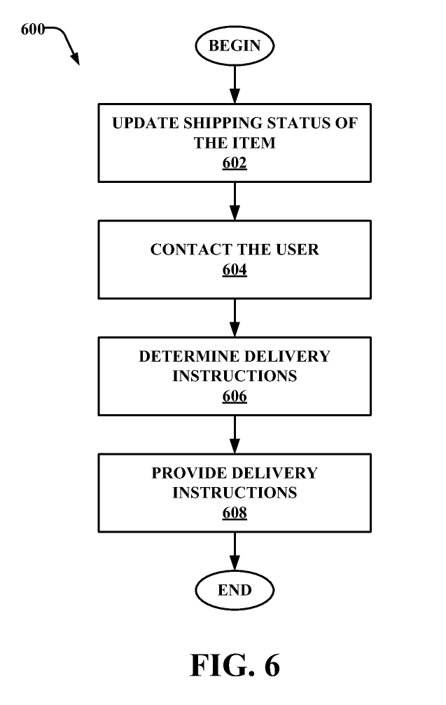

FIG. 6 is a flow chart of another embodiment of a method for providing a flexible shipping delivery. At 602, a shipping status of the item is updated based on the tracking shipping status of the item from the shipping carrier server. At 604, the user is contacted based on the updated shipping status of the item. The shipping delivery preference of the user is then determined. At 606, the delivery instructions are determined from the user. At 608, the delivery instructions of the item are provided to the shipping carrier server.

In another embodiment, instructions from the user are received for a shipping carrier to deliver the item at a local shipping carrier office or at a physical address specified by the user.

In another embodiment, the flexible shipping delivery application 130 determines whether the user is to be physically present at the physical address at a time of delivery of the item or whether the user is to remotely sign for the delivery of the item at the physical address.

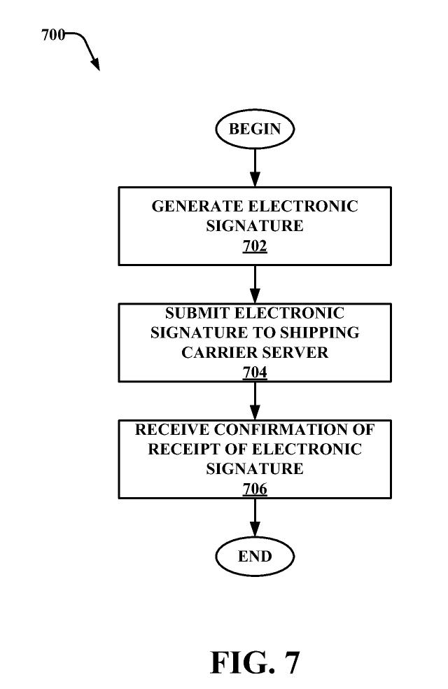

FIG. 7 is a flow chart of one embodiment of a method for providing an electronic signature for a flexible shipping delivery. At 702, an electronic signature of the user is generated based on authenticated information from the user. At 704, the electronic signature of the user is submitted to the shipping carrier server for the delivery of the item at the physical address. At 706, a confirmation of a receipt of the electronic signature of the user is received from the shipping carrier server.

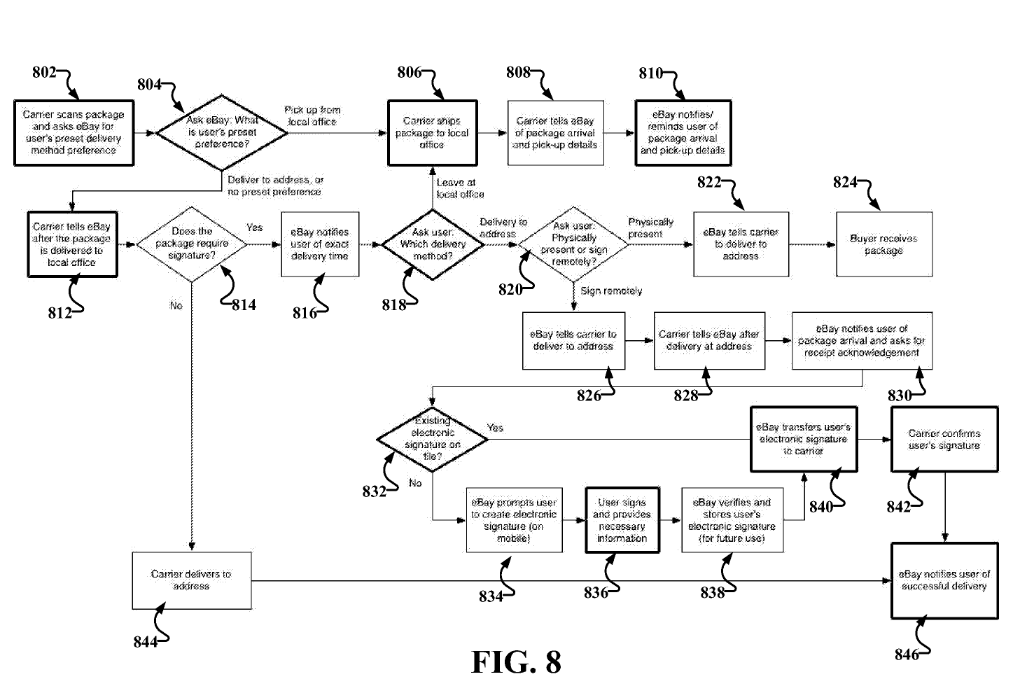

FIG. 8 is a flow chart of one embodiment illustrating a flexible shipping delivery system that notifies and communicates shipping status information, user preferences, and user receipt confirmation between shipping carriers and customers. At 802, a shipping carrier scans a package and asks the flexible shipping delivery application 130 (shown as “eBay”) for a user's preset delivery method preference. At 804, the flexible shipping delivery application determines whether a user's preset preference already exists. If the user's preset preference is for the user to pick up the package from the local office of the shipping carrier, the shipping carrier ships the package to its local office at 806. At 808, the shipping carrier tells the flexible shipping delivery application of the package arrival and gives pickup details. At 810, the flexible shipping delivery application notifies and reminds the user of the package arrival along with the pickup details.

If no user's preset preference exists as determined at 804, or if the user's preset preference is to have the package delivered at a physical address as specified by the user, then the shipping carrier notifies the flexible shipping delivery application after the package has been delivered to a local office of the shipping carrier at 812. At 814, the flexible shipping delivery application determines whether the package requires a signature for delivery. If no signatures are required, the shipping carrier delivers to the physical address specified by the user at 844. At 846, the flexible shipping delivery application notifies the user of the successful delivery at the physical address specified by the user.

If it is determined that the package requires a signature at 814, the flexible shipping delivery application notifies the user of an exact time of delivery at the local office at 816. At 818, the flexible shipping delivery application asks the user for a delivery method. If the user decides to pick up the package at the local office, the package may be left at the local office pursuant to the user's instructions. If the user decides to have the package delivered at a physical address, the flexible shipping delivery application then determines at 820 whether the user will be physically present or will want to sign remotely.

If the user decides to be physically present at the physical address, the flexible shipping delivery application notifies the shipping carrier to deliver at the physical address at 822. At 824, the user receives the package and signs a receipt acknowledgment.

If the user decides to sign remotely, the flexible shipping delivery application notifies the shipping carrier to deliver the package at the physical address at 826. At 828, the shipping carrier notifies the flexible shipping delivery application after delivery of the package at the physical address. At 830, the flexible shipping delivery application notifies the user of the package arrival and requests for a receipt acknowledgment from the user.

At 832, the flexible shipping delivery application determines whether an electronic signature of the user already exists on file with the flexible shipping delivery application. If the electronic signature of the user already exists, the flexible shipping delivery application transfers the user's electronic signature to the shipping carrier at 840. If the electronic signature of the user does not exist on the flexible shipping delivery application, the flexible shipping delivery application prompts the user to create his or her electronic signature at 834. At 836, the user provides his or her signature along with additional necessary information to authenticate the user. At 838, the flexible shipping delivery application verifies and stores the user's electronic signature.

At 842, the shipping carrier confirms receipt of the user's signature for the delivery of the package. At 846, the flexible shipping delivery application notifies the user of the successful delivery of the package at the physical address specified by the user.

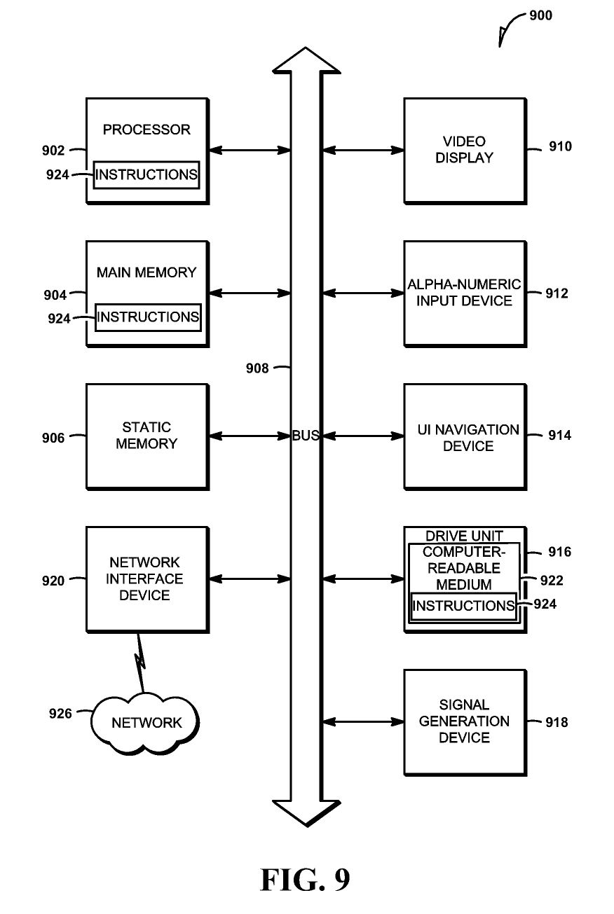

FIG. 9 shows a diagrammatic representation of a machine in the example form of a computer system 900 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., HTTP).

While the machine-readable medium 922 is shown in an example embodiment to be a single medium, the term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media.

What is claimed is:

1. A shipping delivery system, comprising:
an online marketplace interface configured to communicate with an online marketplace application;
a client interface configured to communicate with a client and to receive from the client, a shipping delivery preference of a user for an order of an item from the online marketplace application;
a shipping carrier interface configured to communicate with a shipping carrier server and to receive from the shipping carrier server, a tracking shipping status of the item; and
a processor-implemented flexible shipping delivery engine configured to adjust a delivery option of the item based on the tracking shipping status of the item and the shipping delivery preference.

2. The flexible shipping delivery system of claim 1, wherein the processor-implemented flexible shipping delivery engine further comprises:
a shipping tracking engine configured to update a shipping status of the item based on the tracking shipping status of the item from the shipping carrier server;
a user notification module configured to contact the user based on the updated shipping status of the item;
a user preference module configured to determine the shipping delivery preference of the user;
a user delivery instruction module configured to determine delivery instructions from the user; and
a shipping carrier delivery instruction module configured to provide the delivery instructions for the item to the shipping carrier server.

3. The flexible shipping delivery system of claim 2, wherein the user delivery instruction module further comprises:
a local shipping carrier office delivery module configured to receive an instruction from the user for a shipping carrier to deliver the item at a local shipping carrier office; and
a shipping address delivery module configured to receive an instruction from the user for the shipping carrier to deliver the item at a physical address specified by the user.

4. The flexible shipping delivery system of claim 3, wherein the shipping address delivery module further comprises:
a physical presence module configured to determine that the user is to be physically present at the physical address at a time of delivery of the item; and
a remote presence module configured to determine that the user is to remotely sign for the delivery of the item at the physical address.

5. The flexible shipping delivery system of claim 4, wherein the remote presence module further comprises:
an electronic signature generation module configured to generate an electronic signature of the user based on authenticated information from the user; and
an electronic signature application module configured to submit the electronic signature of the user to the shipping carrier server for the delivery of the item at the physical address, and to receive a confirmation of a receipt of the electronic signature of the user from the shipping carrier server.

6. The flexible shipping delivery system of claim 5, wherein the user notification module is configured to notify the user of the time of the successful delivery of the item at the physical address.

7. The flexible shipping delivery system of claim 3, wherein the user notification module is configured to notify the user of the time of the successful delivery of the item at the local shipping carrier office and pickup details.

8. The flexible shipping delivery system of claim 1, wherein the delivery option comprises delivering the item at a local shipping carrier office for the user to pick up, or delivering the item at a physical address specified by the user.

9. A computer-implemented method comprising:
receiving a shipping delivery preference of a user of a client, the client to place an order for an item on an online marketplace application;
receiving a tracking shipping status of the item provided by a shipping carrier server; and
adjusting a delivery option of the item based on the tracking shipping status of the item and the shipping delivery preference.

10. The computer-implemented method of claim 9, further comprising:
updating a shipping status of the item based on the tracking shipping status of the item from the shipping carrier server;
contacting the user based on the updated shipping status of the item;
determining the shipping delivery preference of the user;
determining delivery instructions from the user; and
providing the delivery instructions for the item to the shipping carrier server.

11. The computer-implemented method of claim 10, further comprising:
receiving an instruction from the user for a shipping carrier to deliver the item at a local shipping carrier office or at a physical address specified by the user.

12. The computer-implemented method of claim 11, further comprising:
determining that the user is to be physically present at the physical address at a time of delivery of the item or that the user is to remotely sign for the delivery of the item at the physical address.

13. The computer-implemented method of claim 12, further comprising:
generating an electronic signature of the user based on authenticated information from the user;
submitting the electronic signature of the user to the shipping carrier server for the delivery of the item at the physical address; and
receiving a confirmation of a receipt of the electronic signature of the user from the shipping carrier server.

14. The computer-implemented method of claim 13, further comprising:
notifying the user of the time of the successful delivery of the item at the physical address.

15. The computer-implemented method of claim 13, further comprising:
notifying the user of the time of the successful delivery of the item at the local shipping carrier office and pickup details.

16. The computer-implemented method of claim 9, wherein the delivery option comprises delivering the item at a local shipping carrier office for the user to pick up, or delivering the item at a physical address specified by the user.

17. A non-transitory computer-readable storage medium storing a set of instructions that, when executed by a processor, cause the processor to perform operations, comprising:
receiving a shipping delivery preference of a user of a client, the client to place an order for an item on an online marketplace application;
receiving a tracking shipping status of the item provided by a shipping carrier server; and
adjusting a delivery option of the item based on the tracking shipping status of the item and the shipping delivery preference.

18. The non-transitory computer-readable storage medium of claim 17, further comprising:
updating a shipping status of the item based on the tracking shipping status of the item from the shipping carrier server;
contacting the user based on the updated shipping status of the item;
determining the shipping delivery preference of the user;
determining delivery instructions from the user; and
providing the delivery instructions for the item to the shipping carrier server.

19. The non-transitory computer-readable storage medium of claim 18, further comprising:
receiving an instruction from the user for a shipping carrier to deliver the item at a local shipping carrier office or at a physical address specified by the user; and
determining that the user is to be physically present at the physical address at a time of delivery of the item or that the user is to remotely sign for the delivery of the item at the physical address.

20. The non-transitory computer-readable storage medium of claim 19, further comprising:
generating an electronic signature of the user based on authenticated information from the user;
submitting the electronic signature of the user to the shipping carrier server for the delivery of the item at the physical address; and
receiving a confirmation of a receipt of the electronic signature of the user from the shipping carrier server.
